(19) United States
(12) Patent Application Publication
(10) Pub. No.: US 2006/0052196 A1
(43) Pub. Date: Mar. 9, 2006

(54) Chain storage unit for products and means to reduce chanin vibrations

(76) Inventors: Mauro Gelli, Lucca (IT); Walter Di Nardo, Lucca (IT)

Correspondence Address: BREINER & BREINER, L.L.C., P.O. BOX 19290, ALEXANDRIA, VA, 22320-0290, US

(21) Appl. No.: 10/514,139

(22) PCT Filed: Mar. 2, 2004
(86) PCT No.: PCT/IT04/00102

§ 371 Date: Nov. 10, 2004

(30) Foreign Application Priority Data
Mar. 13, 2003 (IT) FI2003A000066

(51) Int. Cl. F16H 7/00; F16H 55/30

(52) U.S. Cl. 474/152; 474/148

(57) ABSTRACT

A storage unit for temporary storage of products is described, including at least one flexible member (55), provided with supports (57) for said products, extending and moving along a path defined by a plurality of driving wheels (59, 63), including at least two substantially parallel branches. At least one guiding sliding block (201) is disposed between said two branches, in contact therewith.

### TECHNICAL FIELD

The present invention relates to a storage unit to store elongated products, such as cardboard tubes or the like, comprising at least two flexible members, equipped with supports for said products, extending and moving along respective parallel paths defined by a plurality of driving wheels.

More specifically, although not exclusively, the invention relates to a storage unit in which the flexible members are continuous and extend along respective closed paths.

### STATE OF THE ART

In many industrial fields a filiform or web material is wound on tubular winding cores made of plastic, cardboard or another material. These tubular winding cores (hereinafter also simply called <<cores>>), are stored in a storage unit and gradually fed to the machine that winds the filiform or web material. The products wound on the cores may for example be plastic films, fabrics, non-wovens, paper, so-called tissue paper, or other products in films or in sheets of various types.

In the paper converting industry, to produce rolls of toilet tissue, kitchen towels and similar products processing lines are provided with one or more unwinding devices, which unwind the web material from corresponding reels of large diameter to feed it to a rewinder. The rewinder winds pre-established quantities of web material on cores usually made of cardboard, which are produced by so-called core winding machines normally positioned beside the rewinding machine. The cores are frequently simply accumulated in box storage units from which they are subsequently picked up by a belt or chain conveyor to be fed one at a time into the rewinder. The feed frequency of the cores is currently around 40 cores per minute or higher.

The logs formed by the rewinder have a diameter equal to the diameter of the final product destined for sale and a length equal to a multiple of the length of the finished product. The logs are therefore subsequently cut to form small finished rolls.

In the paper converting industry there is a tendency to use rewinding machines capable of winding logs of increasing axial length, that is to handle web material of increasing width. It has been found that when the cores are of considerable length, they tend to adopt an irregular position in current storage units and even tend to twist around one another, consequently breaking and causing jamming of the automatic flow towards the rewinder. This causes considerable problems during the production phase.

Analogous problems may occur in other sectors in which products of elongated shape and especially products with limited flexural strength must be accumulated and stored in a storage, unit.

Storage units for temporarily storing logs produced by rewinders are currently known, provided with two flexible members in the form of parallel chains, secured to which are continuous oscillating supports extending from one flexible member to the other, on each of which a log is placed. The flexible members are disposed at a greater distance than the length of the logs to be handled. An example of a storage unit of this type is described in U.S. Pat. No. 6,053,304.

WOA-03002437 discloses a storage unit for tubular cores intended for the production of rolls of wound web material, typically logs of tissue paper.

All these storage units are provided with two or more chains, or other flexile members, to which supporting means for the products to be stored, either cores or logs, are connected. The continuous or discontinuous motion of the flexible members causes vibrations, generated by wheels around which the chains are entrained. The tendency towards products of increasing axial length makes these vibrations more critical.

### OBJECTS AND SUMMARY OF THE INVENTION

The object of the present invention is to produce a unit for temporarily storing elongated products—especially although not exclusively tubes or tubular winding cores, logs of wound material or the like—which overcomes the drawbacks of prior art storage units and which reduces vibrations in the chains or other flexible members supporting the products to be stored.

These and other objects and advantages, which shall become apparent to those skilled in the art by reading the text hereunder, are obtained with a storage unit for temporary storage of products, including at least one flexible member, provided with supports for said products and extending and moving along a path defined by a plurality of driving wheels, including at least two substantially parallel branches, wherein at least one guiding sliding block is disposed between said two branches, in contact therewith. The sliding block prevents or reduces the propagation of vibrations from the driving wheel(s) along the two branches of the flexible member.

Further advantageous features and embodiments of the storage unit according to the invention are set forth in the attached dependent claims.

In a per se known way each of the closed paths along which the continuous flexible members move can be defined by a first and by a second series of driving wheels with fixed axle, and by a first and by a second series of driving wheels with moving axle carried by a carriage or moving unit between the first and the second series of driving wheels with fixed axle. An architecture of this type is used in storage units for temporarily storing logs of web material and is described for example in U.S. Pat. No. 6,053,304. In this case, the sliding blocks are advantageously associated with the fixed wheel and with the wheels having moving axles carried by the moving unit of the storage unit.

### BRIEF DESCRIPTION OF THE DRAWINGS

The invention shall now be better understood by following the description and attached drawing, which shows a non-limiting practical embodiment of the finding. More specifically,

FIG. 1 shows a side view of the storage unit according to the invention in a possible embodiment;

FIG. 2 shows a side view along line II-II of FIG. 1;

FIG. 3 shows a detail of an upper driving wheel having fixed axle with its respective sliding block;

FIG. 4 shows a detail of the movable unit and of the respective sliding guiding blocks arranged between adjacent wheels of said unit;

FIG. 5 shows a local section along line V-V in FIG. 4; and

FIG. 6 shows a front view of a guiding sliding block.

### DETAILED DESCRIPTION OF THE PREFERRED EMBODIMENT OF THE INVENTION

In the description hereunder reference is made to a storage unit specifically produced to handle and store tubular cardboard cores for winding logs of web material, such as tissue paper, to produce rolls of toilet paper, kitchen towels or the like. It must, however, be understood that the same principles may be adopted to produce storage units for other types of elongated products with analogous advantages.

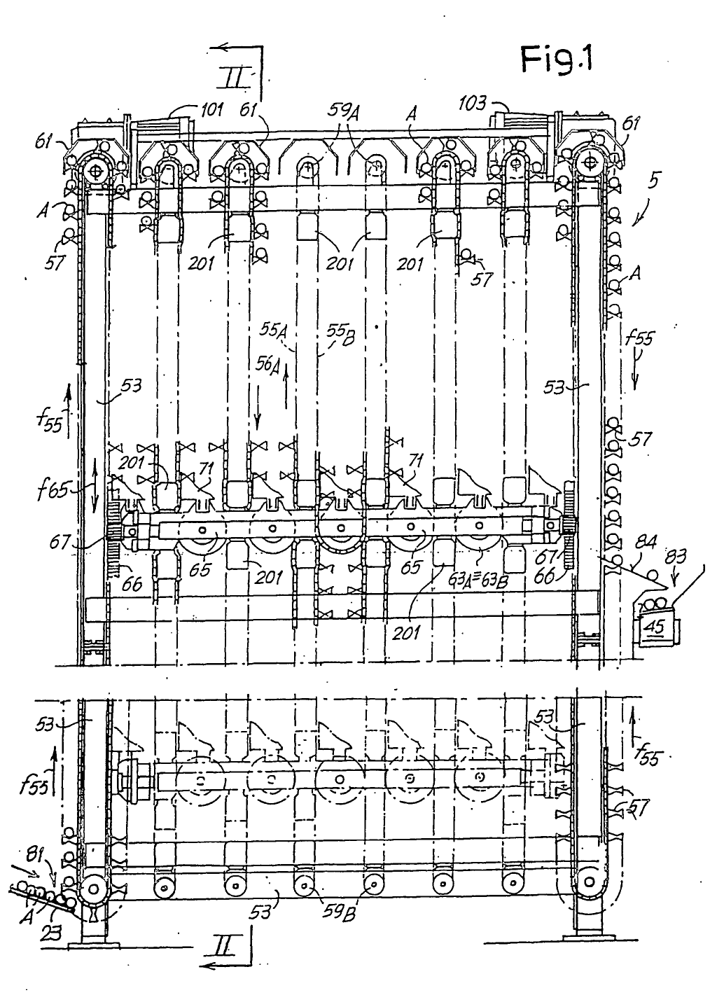

FIG. 1 shows a side view of the storage unit, generically indicated with 5. The cores A, produced substantially continuously by core winders (not shown) are transported to a chute 23. From here, through gravity, the cores roll to the feed area of the storage unit 5.

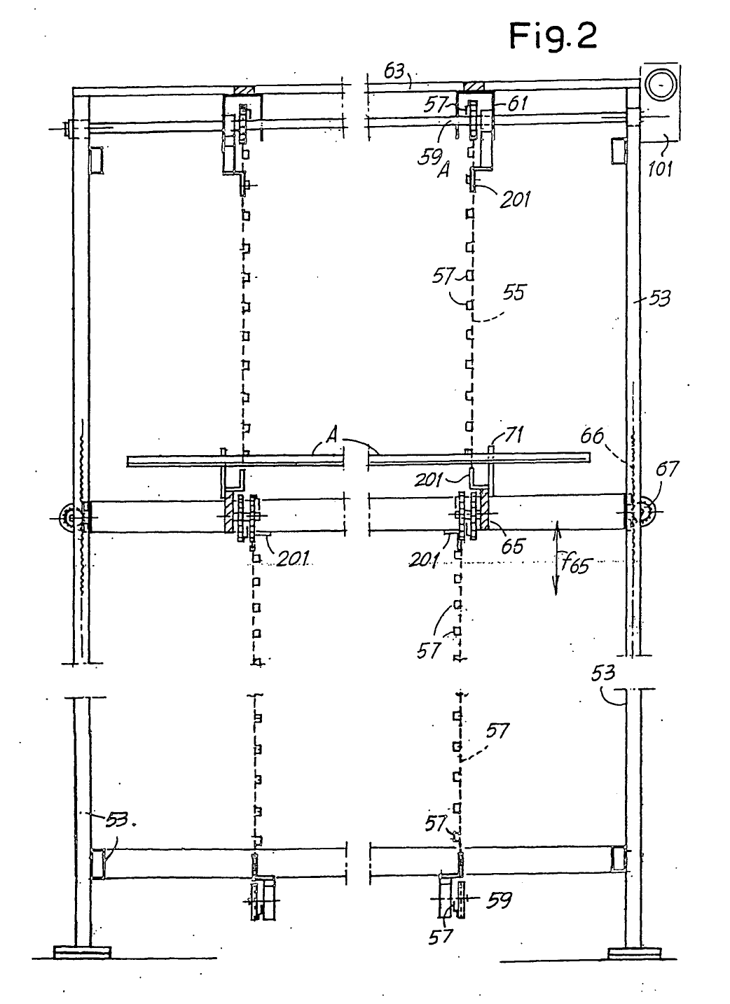

The storage unit 5 comprises a fixed structure 53, carrying a first series of toothed chain wheels 59A in the upper area and a second series of toothed chain wheels 59B in the lower area. The axles of the chain wheels 59A and 59B of the two series are fixed in respect of the structure 53 of the storage unit. Chains 55 are driven around the toothed wheels. In practice, as can be seen in particular in FIG. 2, the storage unit has two continuous flexible members constituted by chains 55, lying more or less on the same number of vertical planes parallel to each other and defining substantially equal closed paths. A single chain 55 and a single path are shown in FIG. 1, it being apparent that the other chain overlaps the one visible in the drawing. Analogously, respective toothed wheels which define the closed paths of the two chains are provided. Hereunder, the single chain 55, the relative driving wheels and the closed path along which it extends will be described. It must be understood that the storage unit may also have more than two chains or other flexible members parallel to one another, especially when this is required by the length of the products to be handled.

The path of each chain 55 is defined, as well as by the upper and lower toothed wheels 59A and 59B with fixed axles, carried by the fixed structure 53, also by a first series of toothed chain wheels with moving axle 63A and by a second series of toothed chain wheels with moving axle 63B.

The toothed wheels with moving axle 63A, 63B are supported by a moving unit or carriage 65 sliding vertically according to the double arrow f65 and guided along vertically extending racks 66, integral with the fixed structure 53, which mesh with pinions 67 carried by the unit 65. Opposed and coaxial pinions are keyed onto a common shaft 68. The arrangement of the racks 66 and pinions 67 with respective shafts allows the moving unit 65 always to translate parallel to itself without tilting. Moreover, lateral guide rollers 77, 78 are provided on corresponding vertical guides.

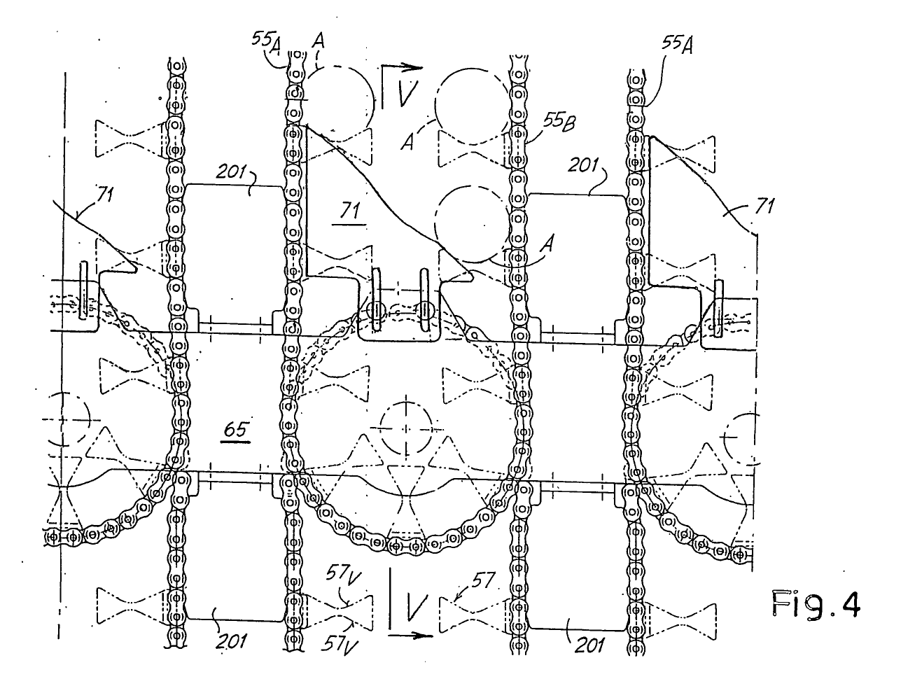

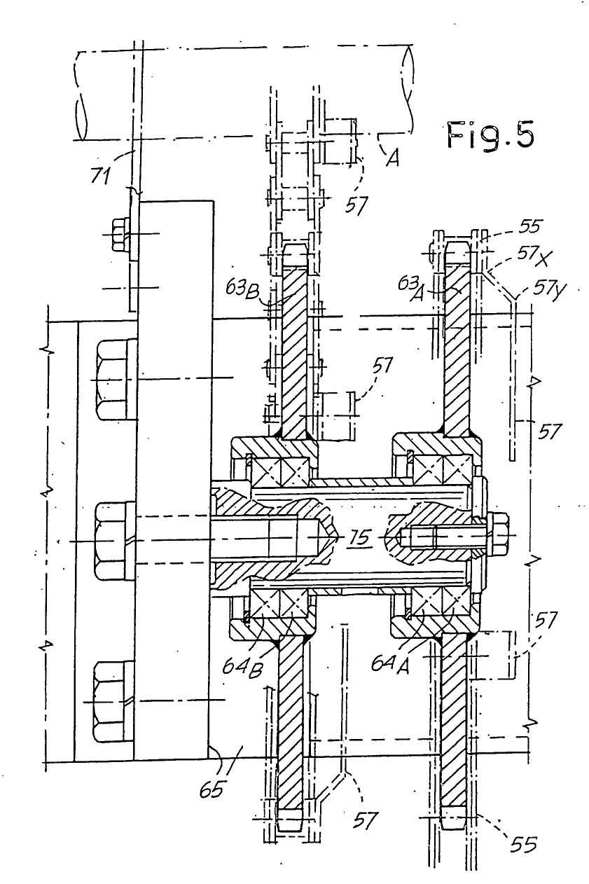

The wheels with moving axle of the two series of toothed wheels 63A, 63B are disposed coaxially, so that a toothed wheel 63B of the second series is always coaxial with each toothed wheel of the first series 63A (see FIG. 5). The driving wheels 63A and 63B with moving axle are coaxial in as much as for each pair of wheels 63A, 63B, the wheel that drives the corresponding branch of the chain 55 coming from the driving wheel 59A with fixed upper axle (indicated with 63A) and the wheel that drives the branch of the chain 55 coming from the respective driving wheel 59B with fixed lower axle are idly supported by means of bearings 64A, 64B mounted on a corresponding shaft 75 in turn carried cantileverly by a beam which is a part of the carriage or moving unit 65 (see FIG. 4).

Supports 57 are integral with each chain 55. Each of these is rigidly fixed to a respective link of the chain 55, as shown in more detail in FIG. 5. As is visible in FIG. 1, the supports 57 all project from the same side of the chain with which they are integral. More specifically, they extend in a substantially parallel direction to the plane on which the chain 55 to which they are secured lies, that is parallel to the plane of the figure.

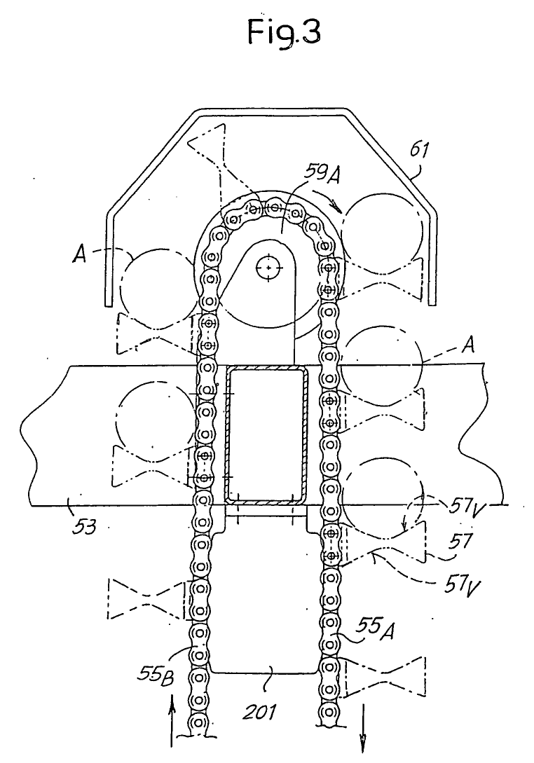

The supports 57 have two opposed and symmetrical V-shaped resting surfaces, indicated with 57V in FIG. 3. As shall be more apparent from the description of the operating method of the storage unit, thanks to this layout the supports 57 can receive and support the cores A on one or other of the two opposed V-shaped surfaces, so that in the passage around the upper driving wheels 59A the cores A can pass from a support 57 to the support downstream (in respect of the movement of the chain 55, indicated by the arrow f55). Transfer from a surface 57V to an opposed surface 57V (although of another support) also occurs in proximity to the driving wheels 63A, as shall be described in greater detail hereunder.

Moreover, as can be seen particularly in FIG. 5, each support 57 is constituted by a laminar component secured to a respective link of the chain 55 and bent in 57X and 57Y so that the resting surfaces 57V are on planes parallel to the median plane of the driving wheels 63A, 63B, but distanced from the wheels so as not to interfere with them.

As can be seen in FIG. 1, the path of the chain 55 and the arrangement of the supports 57 secured to it are such that around the upper driving wheels with fixed axle 59A the supports 57 are located on the outside of the path, that is they extend radially away from the axle of the toothed driving wheels 59A, so as not to interfere with these wheels 59A. This is also the case in the stretch of the path of the chain around the lower toothed wheels with fixed axle of the second series 59B.

A respective guiding surface 61 extends around each of the toothed wheels 59A. This guiding surface 61 prevents the cores A from falling when the supports 57 on which they are resting move around the axle of the wheel 59A.

Moreover, the arrangement of the chain 55 and of the supports 57 is such that in the driving area around the driving wheels with moving axles of the first and of the second series 63A and 63B, the supports 57 are facing radially inwardly, that is towards the axis of the respective wheel 63A, 63B and are therefore positioned at the side of the plane on which the wheels lie, as can be seen in particular in FIGS. 4 and 5.

In proximity to each pair of driving wheels 63A, 63B, above the axle of the wheels, a respective exchange or transfer member 71 is positioned. As shall be apparent hereunder, each transfer member 71 receives the cores A resting on the supports 57 positioned on the branch 55A (see in particular FIG. 3) of the chain 55 upstream of the respective driving wheel 63A and transfers them to the supports 57 positioned on the branch 55B of the chain 55 downstream of the driving wheel 63A in respect of the direction of feed f55 of the chain along the path. In substance, the tubular cores A pass from the descending branch 55A to the ascending branch 55B tangent to each toothed driving wheel 63A, by-passing the wheel.

In this way the tubular cores A follow a trajectory which avoids each driving wheel 63A, 63B with moving axle. In substance, the path of the cores by-passes the driving wheels with moving axle carried by the moving unit 65. This on the one hand makes it possible to handle elongated products (such as tubular cores A) resting on the supports 57 positioned at a lesser distance than the axial length of the products (with the products which project even considerably beyond the surfaces defined by the supports 57) and on the other allows the driving wheels 63A and 63B to be disposed coaxially rather than one above the other, as is the case in traditional storage units, with the aforesaid advantages in terms of reducing the overall dimensions and simplifying the construction.

In particular, in the embodiment of the invention shown in the attached drawings, the transfer member 71 comprises a transfer surface 71A intersecting the trajectory of the supports 57 carried by the branches upstream and downstream (55A, 55B) of the driving wheel 63A, and inclined from the top downwards and from the branch upstream 55A towards the branch downstream 55B to cause transfer of the tubular cores A through gravity. Before reaching the respective driving wheel 63A each support 57 deposits the core A on the surface 71A. Due to the inclination of the surface 71A, each core rolls to the other branch 55B of the chain. Here it finds another support 57 that picks it up and conveys it to the subsequent driving wheel with moving axle 63A.

Therefore, the supports 57 travel the circumference of the wheels 63A without the cores, as they deposit the cores on the transfer member upstream of the wheel and pick them up again once they are downstream of the wheel. The diameter of the driving wheels 63A, 63B and the longitudinal dimension of the supports 57 allow the supports 57 to move around the supporting hub of the driving wheels without knocking against it.

The transfer members 71, which may be constituted by simple appropriately cut lengths of sheet metal, may advantageously be adjustable in position in respect of the axle of the respective wheels 63A, so that each core A reaches the respective branch 55B of the chain more or less at the moment in which a support 57 integral with the branch 55B transits in front of the surface 71A of the transfer member. This prevents the core from resting on the chain 55 or in any case reduces the contact time with the chain. A sufficiently limited distance between the lower end of the surface 71A and the branch 55B of the chain ensures that the core A does not come into contact with the underlying wheel 63A or 63B.

Operation of the storage unit described hereinbefore is as follows. In a loading station, indicated generically with 81, the cores A coming from the chute 23, are individually picked up by supports 57 carried by the chain 55. The direction of feed of the branch of the chain 55 facing the chute 23 is from the bottom upwards and this causes the individual cores to be raised from the chute towards the top of the storage unit. As the storage unit is provided with two chains 55 parallel with each other, each core is picked up resting on a pair of supports 57 integral with the two chains 55.

Continuing feed of the chains 55 according to the arrow f55, the cores A picked up from the chute 23 rotate around the axle of the first driving wheel with fixed axle 59A, that is around the top left wheel in FIG. 1. The path of the cores then continues until it intercepts the transfer member 71 associated with the first of the driving wheels with moving axle 63A. Thanks to the operation described hereinbefore, before the cores interfere with this wheel they are transferred by the transfer member 71 by-passing the wheel 63A (and the wheel 63B coaxial to it) to the branch 55B of the chain 55 downstream of this wheel.

From here the cores continue substantially in the same way along the stretch of path which extends between the upper driving wheels with fixed axle 59A and the driving wheels with moving axle 63A, again by-passing the driving wheels 63A (and the driving wheels 63B coaxial to it) thanks to the transfer members 71.

Finally, the cores reach the rightmost vertical stretch in FIG. 1, which moves from the top downwards. Along this stretch each single core is intercepted in an unloading station 83 by a chute 84, formed of two or more inclined section bars, which cause it to drop onto the conveyor 45 (FIG. 1).

The remaining stretch of the path of each chain 55, which extends between the lower driving wheels with fixed axle 59B and the driving wheels with moving axle 63B, has no tubular cores A, and the various supports 57 are thus empty when they reach the lower end of the first ascending stretch of the chain, in front of the chute 23.

Movement is imparted to the chains 55 by a pair of motors 101 and 103 disposed on the upper part of the fixed structure 53, which cause the chains to move individually respectively in the feed area and in the unloading area of the cores. This makes it possible, in a per se known way, for a different number of cores A to be fed to the inlet than the number of cores unloaded at the outlet during the unit of time. The excess is stored in the storage unit if the feed flow rate is above the delivery flow rate. In the opposite case, the shortage in flow will be supplied by the material stored in the storage unit, with consequent reduction in the number of cores contained in the storage unit. Modulation of the speed of the first ascending branch of the chain makes it possible to slow down or stop the chain in front of the chute 23 when the number of cores per unit of time reaching it is limited or the flow of cores coming, from the core winders actually stops. This guarantees that all the supports 57 located in the stretch of path from the feed station to the delivery station are filled with the respective tubular cores A, to obtain a regular flow of product being delivered.

If the flow rates of tubular cores A being fed and delivered are the same, the moving unit 65 maintains the same position. However, if the two flow rates are temporarily different from each other, the moving unit 65 will move. It will move upwards if the quantity of cores delivered during the unit of time is greater than the quantity of cores fed and will move downwards in the opposite case.

As the chains 55 are driven around toothed driving wheels 59A, 59B, 63A, 63B, they are usually subject to vibrations, due to inevitable impacts between the links of the chains and the teeth of the toothed wheels, and to the fact that the chains bend according to polygons whose sides correspond to the single chain links.

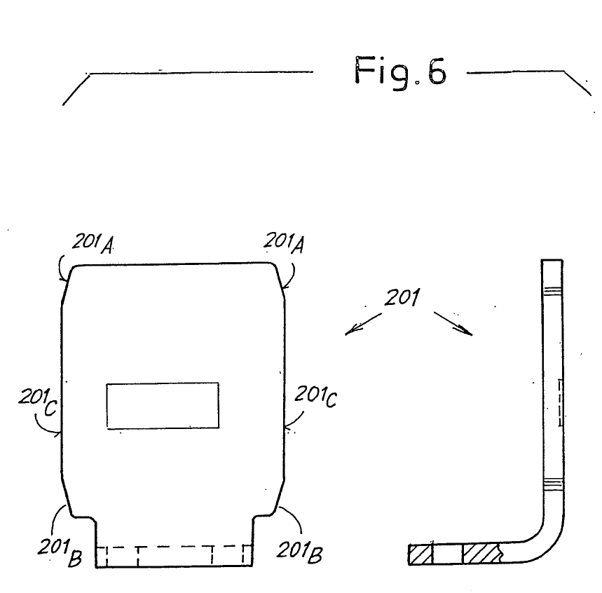

To reduce these vibrations or actually eliminate propagation along the branches of the chain, the arrangement according to the invention is provided. In the preferred embodiment, it provides that guiding sliding blocks 201 are associated under each upper toothed driving wheel 59A with fixed axis (if need be excluding the two end wheels). Each sliding block 201 is in contact with two parallel branches of the respective flexible member 55, which are in contact with the corresponding driving wheel. The width of the sliding block is slightly greater than the distance said two branches would adopt if they were normally extended between the driving wheel 59A and the corresponding underlying wheels 63 carried by the moving unit 65. They have two lateral sides (FIG. 6) constituted by a rectilinear edge 201C and by two bevels 201A, 201B. The flexible member is therefore diverted slightly from its normal rectilinear path passing on one or other of the bevels 201A, 201B so that each branch is divaricated in respect of the parallel branch driven by the same driving wheel 59A. An analogous situation is obtained for the lower driving wheels 59B (see FIG. 1).

The same sliding blocks 201 are also mounted on the moving unit 65. In more detail, two series of sliding blocks are disposed on the unit 65, respectively associated with the branches extending from the wheels 65A towards the wheels 59A and, respectively, from the wheels 65B towards the wheels 59B. In both cases they are disposed between parallel branches in contact with two driving wheels 65A or 65B adjacent to each other and not between branches driven by the same wheel.

The branches of the flexible members 55 are thus held in a slightly divaricated position adjacent to the driving wheels. This contact and slight forcing on the driving members substantially blocks propagation of vibrations from the driving wheels along the free branches of the flexible members.

It will be understood that the same advantage is obtained in similar arrangements of guiding sliding blocks on storage units having a different structure and also for storing products and materials different than those described herein.

It is understood that the drawing only shows only a practical example of the invention, as said invention may vary in forms and arrangements without however departing from the scope of the concept underlying the invention. Any reference numerals in the attached claims are provided purely for the purpose of facilitating reading in the light of the description hereinbefore and of the attached drawings and do not limit the scope of protection of the claims.

1. A storage unit for temporary storage of products, including at least one flexible member, provided with supports for said products, extending and moving along a path defined by a plurality of driving wheels, including at least two substantially parallel branches, characterized in that at least one guiding sliding block is disposed between said two branches, in contact therewith.

2. Storage unit as claimed in claim 1, characterized in that said sliding block is disposed in the vicinity of one or more driving wheels, in contact with said parallel branches of the respective flexible member.

3. Storage unit as claimed in claim 1, characterized in that the width of said sliding block is greater than the distance between said two parallel branches of the flexible member, said branches being slightly divaricated by said sliding block.

4. Storage unit as claimed in claim 1, characterized in that it includes two parallel flexible members.

5. Storage unit as claimed in claim 1, characterized int hat said flexible member(s) are continuous and extend along closed paths.

6. Storage unit as claimed in claim 1, characterized in that said flexible member(s) are chains and said driving wheels are toothed chain driving wheels.

7. Storage unit as claimed in claim 1, characterized in that each of said paths is defined by at least a first and a second series of driving wheels having fixed axles and at least a first and a second series of driving wheels having moving axles carried by a moving unit between the first and the second series of wheels having fixed axles.

8. Storage unit as claimed in claim 7, characterized in that a respective guiding sliding block is disposed at the wheels of said first and of said second series of driving wheels with fixed axle, in contact with the two branches of the flexible member in contact with the respective driving wheel with fixed axle.

9. Storage unit as claimed in claim 7, characterized in that said moving unit (65) carries respective guiding sliding blocks (201) disposed between parallel branches of the flexible manner between two adjacent driving wheels carried by said moving unit.

10. Storage unit as claimed in claim 7, characterized in that said driving wheels having movable axles have a larger diameter than the driving wheels having fixed axles.

11. Storage unit as claimed in claim 1, characterized in that said guiding sliding blocks have sides with bevels.

12. Storage unit as claimed in claim 11, characterized in that said sliding blocks have sides with parallel rectilinear portions extending between said bevels.
